(19) United States
(12) Patent Application Publication
(10) Pub. No.: US 2025/0303471 A1
(43) Pub. Date: Oct. 2, 2025

(54) A PROCESS OF THREE-DIMENSIONAL PRINTING WITH SUPPORT STRUCTURES

(71) Applicant: THINKMETAL PRIVATE LIMITED, Chennai (IN)

(72) Inventors: Shubhabrata DATTA, Howrah (IN); Sabyasachi GHOSH, Chennai (IN); Arushi SHARMA, Chennai (IN)

(21) Appl. No.: 18/865,689

(22) PCT Filed: May 14, 2023
(86) PCT No.: PCT/IB2023/054961

§ 371 Date: Nov. 14, 2024

(30) Foreign Application Priority Data
May 14, 2022 (IN) 202241022274

(51) Int. Cl. B22F 10/43; B22F 10/18; B22F 12/55; B33Y 10/00; B33Y 30/00; B33Y 70/10

(52) U.S. Cl. CPC B22F 10/43; B22F 10/18; B22F 12/55; B33Y 10/00; B33Y 30/00; B33Y 70/10

(57) ABSTRACT

The present invention introduces a solution to the challenges encountered when printing overhanging, fragile, and complex structures in Fused Filament Fabrication (FFF) metal three-dimensional (3D) printing by utilizing graphite as the material for support structures. In FFF metal 3D printing, selecting suitable support structures becomes problematic due to the requirement of a sintering capability matching that of the primary metal, easy removal of the support structure and no damage to the primary metal material. Graphite is chosen as the ideal material for support structures due to its compatible sintering window, thermal expansion properties, and ease of separation from the primary structure after sintering.

### FIELD OF THE INVENTION

The present invention relates to the field of additive manufacturing/three-dimensional printing, specifically addressing the challenges associated with supporting overhanging structures, fragile structures, and complex structures during the printing process.

### BACKGROUND AND OBJECTIVES OF THE INVENTION

Additive manufacturing is a process of creating three-dimensional objects by joining materials, rather than removing them as in subtractive manufacturing. One example of additive manufacturing is 3D metal printing, which involves depositing material layer by layer to form a 3D structure.

Desktop 3D metal printing is a valuable tool for rapid prototyping and print-and-fit applications in various settings, including R&D centres, design studios, and educational institutes. Metal 3D printing also has gained significant attention in recent years. It has become increasingly popular in industries such as aerospace, medical, and automotive due to its ability to produce complex geometries, reduce material waste, and create parts with improved mechanical properties. The metal 3D printing process involves the use of a high-power energy source, such as a laser or electron beam, to melt metal powder or wire and deposit it layer by layer to form a three-dimensional structure. This process is also known as selective laser melting (SLM) or electron beam melting (EBM). One of the main advantages of metal 3D printing is the ability to create parts with complex geometries that cannot be manufactured using traditional manufacturing techniques. This enables designers to create lightweight, high-performance components that are optimized for their specific applications. Metal 3D printing also allows for the production of small batches of parts at a lower cost, which is particularly useful for niche applications.

Three-dimensional printing, also known as additive manufacturing, via Fused Filament Fabrication (FFF) has revolutionized various industries by enabling the fabrication of intricate and customized structures with unprecedented design freedom. This innovative technology has found applications in various fields, including aerospace, automotive, medical, and consumer goods. However, the successful printing of overhanging structures, fragile structures, and complex structures poses significant challenges in the field of three-dimensional printing. One of the key challenges encountered in three-dimensional printing is the need for support structures. Support structures are essential to provide stability and prevent deformation during the printing process, particularly when dealing with overhanging structures or intricate geometries. These structures serve as temporary supports for the printed object until it reaches sufficient structural integrity. The support structures need to be robust enough to withstand the forces exerted during the printing process and in the handling process post 3d-printing, yet easily removable once the printing & sintering is complete. In the context of Fused Filament Fabrication (FFF) metal three-dimensional printing, selecting suitable support structures becomes very critical.

Metal 3D printing, also known as metal additive manufacturing, has gained significant attention for its potential to fabricate complex metal parts with superior mechanical properties. However, metal 3D printing presents unique challenges due to the requirement of sintering the metal powder to achieve full density and mechanical strength. Sintering is the process of heating the metal powder below its melting point, causing the particles to bond together could be referred to as atomic diffusion. The challenges in FFF metal 3D printing is to select a support structure material that can withstand the high temperatures required for sintering the metal powder. These support structures must possess a sintering capability that is similar to the primary metal material. If the support structures material cannot withstand the sintering temperatures or do not sinter in a similar window as the primary metal, it can lead to inconsistencies in the final part, distortion, or inadequate support during the printing process.

Conventionally, ceramics have been widely used as support structures in FFF metal 3D printing due to their high-temperature resistance, compatibility with sintering processes and easy removal of the support material post sintering. Ceramics exhibit excellent thermal stability and mechanical strength at elevated temperatures, making them suitable for supporting metal parts during sintering. However, ceramics have some drawbacks that limit their effectiveness as support structures. Ceramics are generally brittle, making them prone to cracking or breaking. Moreover, sometimes the removal of ceramic support structures could be challenging and time-consuming, especially in small & tricky areas. Therefore, there is a need for an alternative support structure material that overcomes the limitations of conventional ceramics. This alternative material should possess sintering capability compatible with the primary metal material, exhibit thermal stability, and facilitate easy removal from the printed part after sintering. The present invention addresses these challenges by introducing graphite as the material for support structures in FFF three-dimensional metal printing, particularly in the context of FFF metal additive manufacturing. Graphite is an excellent material for support structures due to its unique properties and characteristics. Graphite is a form of carbon with a layered structure consisting of hexagonally arranged carbon atoms. It exhibits remarkable thermal stability, high-temperature resistance, low coefficient of friction, and a relatively low coefficient of thermal expansion. Graphite can withstand high temperatures without significant expansion, making it an ideal material for supporting metal parts during the sintering process. The low thermal expansion of graphite ensures that the support structures do not exert excessive pressure on the primary metal material structure, minimizing the risk of any geometric and dimensional distortion or deformation. Furthermore, graphite possesses a sintering window that is compatible with the sintering range of various metals used in metal 3D printing. The sintering window refers to the temperature range at which a material undergoes sintering. By selecting graphite as the support structure material, it becomes possible to process both the primary metal and the support structure simultaneously, ensuring 3d printing of complex/overhanging geometries are easy to separate from their support structure and the support structures do not damage the primary metal material part.

Graphite/graphite mixture also emerges as a particularly advantageous and economically viable option for support structures in the field of 3D printing. Its unique properties make it highly suitable for supporting complex structures during the additive manufacturing/3d printing process. However, it is important to consider alternative options that can also serve as support structures, providing flexibility and accommodating different manufacturing requirements. One of the key advantages of using a graphite/graphite mixture as a support structure material is its cost-effectiveness. Graphite/graphite mixture is a readily available and relatively inexpensive material, making it an attractive choice for 3D printing applications. The cost efficiency of graphite-based support structures can significantly contribute to the overall affordability of the process. In addition to graphite, several other materials can be used as alternatives for support structures in metal additive manufacturing/FFF metal 3D printing.

Clay, ceramics, organic materials, metals, and inorganic materials like Plaster of Paris (POP) offer different characteristics and benefits, depending on the specific requirements. Clay is a widely available and inexpensive material that can be easily shaped and removed from the main structure after printing. Its malleability and low cost make it suitable for rapid prototyping. Ceramics, such as Alumina, Calcium Sulphate and Silica, possess excellent high-temperature resistance and can withstand the sintering process. They offer stability during printing and can be subsequently removed without causing damage to the primary structure and are conventionally used for FFF metal 3d printing. Organic materials, including various carbon allotropes, offer unique properties such as high thermal stability and low thermal expansion. These materials are advantageous in situations where extreme heat is involved during the manufacturing process. Carbon allotropes, such as graphene, can be particularly suitable for supporting delicate and intricate structures.

Inorganic materials like Plaster of Paris (POP) offer ease of removal and compatibility with various primary materials. PoP can be dissolved or physically removed, leaving behind a clean surface without causing damage to the main structure. The selection of an appropriate support structure material depends on various factors, including the desired properties of the final product, the specific requirements of the printing process, and the economic viability of the materials. Each alternative option presents its own advantages and considerations, offering flexibility in choosing the most suitable support structure material for a given application. In conclusion, while graphite/graphite mixture is a highly economical choice for support structures in 3D printing, alternative options such as clay, ceramics, organic materials, metals, and inorganic materials like Plaster of Paris (POP) can also be employed depending on the specific needs of the manufacturing process. The selection of the most suitable support structure material should take into account factors such as cost-effectiveness, compatibility with the primary material, ease of removal, and overall performance requirements. By considering these factors, manufacturers can optimize the additive manufacturing process and achieve high-quality, cost-efficient results.

### SUMMARY OF THE INVENTION

The present invention intends to provide a solution to the above drawbacks of the 3D printing of complex structures. Accordingly, the present invention proposes to use graphite or graphite mixture as the material for support structures for 3D printing. The sintering window for graphite is 700-950 degree Celsius, which is compatible with the sintering range of the parent material. Apart from this, graphite is selected due to its thermal expansion properties. It can withstand high temperatures without showing much expansion which is especially integral as a support structure material as it would not cause distortion to the primary structure. The three dimensional would have two print head where each of them extrudes the primary material and graphite respectively, printing the primary structure and the support structure as per required. The two materials will be sintered simultaneously in the sintering window followed by removal of the support structure from the primary structure using post processing.

Additive manufacturing is a manufacturing technique wherein the product is built from ground up. In the process of doing so overhanging, fragile, complex structures often require support structure to enable printing. The solution currently used in the 3D printing sector is the use of ceramics as support structures. The differentiating factor amongst the two is that graphite and the parent material have similar sintering window that allow the processing to occur simultaneously for both. The thermal expansion properties make the material a good fit for the intended application. Also, graphite and/or graphite mixture is one the economically viable options for support structures in 3D printing.

In another embodiment of the present invention, ceramics (Calcium Sulphate, Silica etc.), organic materials (Carbon allotropes), metals (Copper, Stainless steel) and other materials that can be removed easily from the main structure, feasible sintering window, and economic viability can also be used as support structure.

Thus, according to the main aspect of the invention, a method of 3D printing uses graphene/graphite mixture as support structure material, the method comprising the steps of: (i) printing both the primary material along with the support structure; (ii) debinding and sintering of the materials simultaneously; (iii) obtaining the sintered metal part and the support structure; and (iv) removal of the support structure from the primary material.

In yet another embodiment of the present invention, the part will be printed using two print heads, printing the primary material and support material respectively. The combined green part will then be debinded and sintered together as they have similar sintering windows. The support structure will be removed from the primary structure post sintering. The final will hence be obtained containing only the primary structure.

The presence of a support structure ensures shrinkage reduction in the main structure. The thermal expansion properties of the support structure material also prevent it from expanding it at high temperatures, which in turn prevents the distortion of primary structure. Further, the sintering windows of the primary material and the support structure material are similar which allows them to be processed simultaneously, and also the support structure can be easily separated from the primary structure. The material of the support structure is economically viable to use.

### BRIEF DESCRIPTION OF DRAWINGS

FIG. 1A is a schematic diagram of an apparatus for three-dimensional printing metal objects via fused filament fabrication technique, wherein
0. An apparatus for forming three dimensional objects using fused filament fabrication technique,
1. Is the front panel of the apparatus,
2. Is the top panel of the apparatus,
3. Is a top transparent prrping window,
4. Is the back panel of the apparatus,
5. Is the transparent side peeping window of the apparatus,
6. Is the transparent front door of the apparatus,
7. Is the transparent front door hinge supporter of the door of the apparatus,
8. Is the door knob of the apparatus,
9. Is an interactive display unit of the apparatus,
10. Is the display mount of the apparatus;

FIG. 1B is the schematic diagram of the apparatus for three-dimensional printing metal objects via fused filament fabrication technique from the front view;

FIG. 1C is the schematic diagram of the apparatus for three-dimensional printing metal objects via fused filament fabrication technique from the side view;

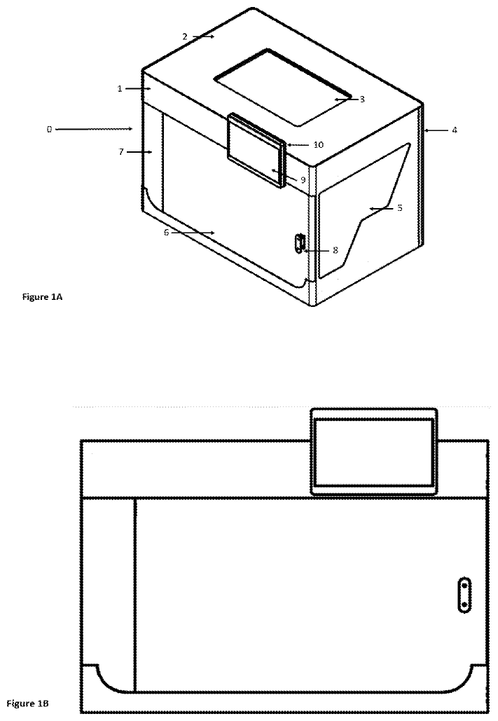

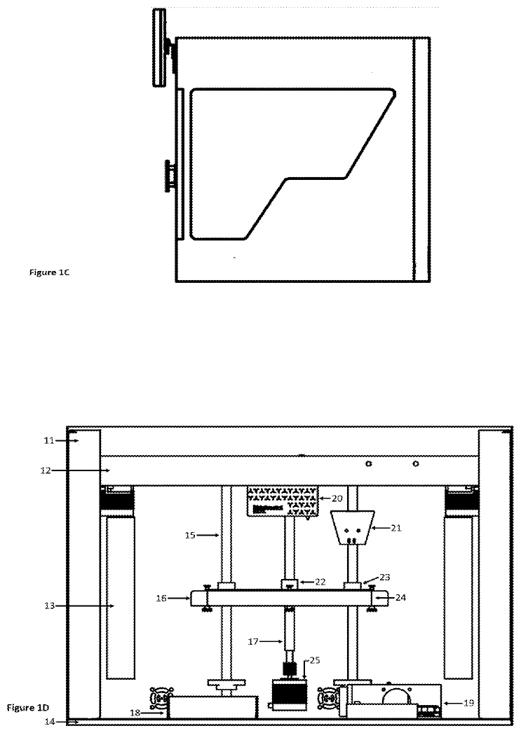

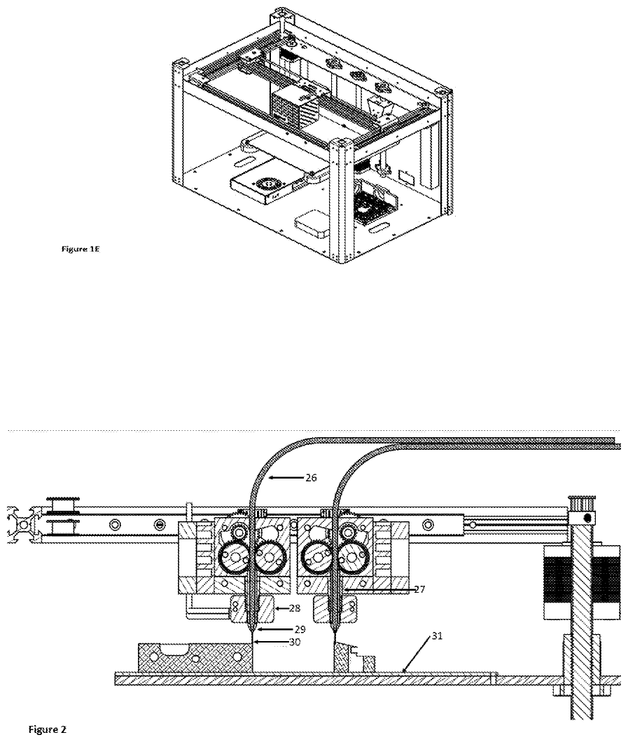

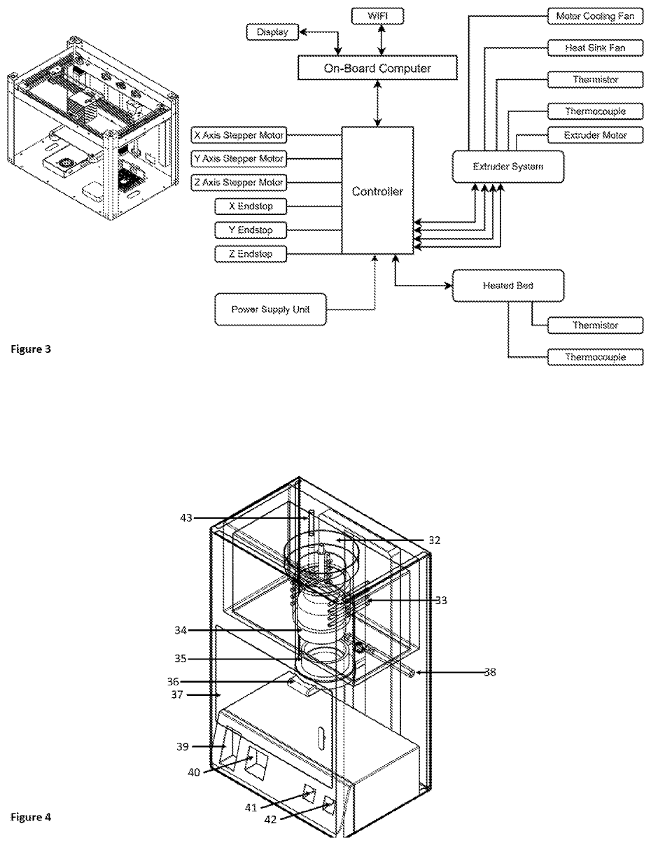

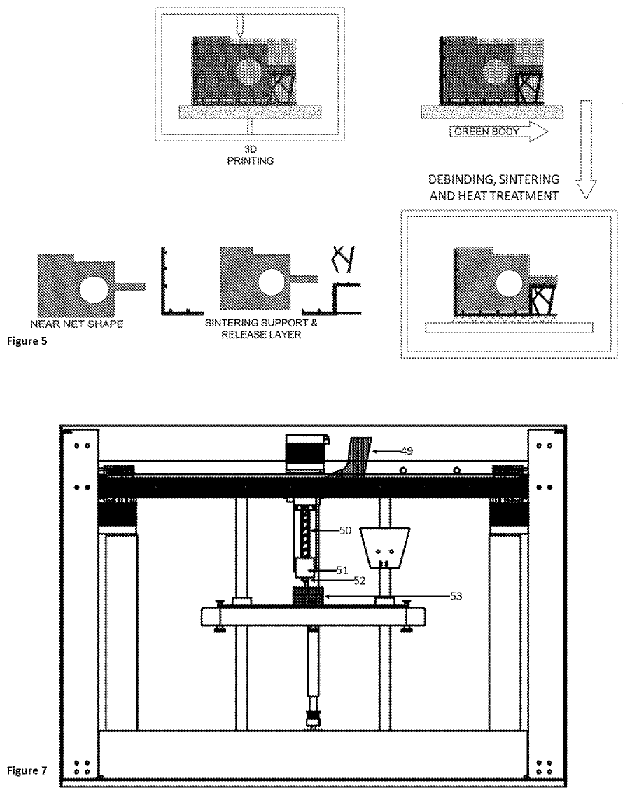

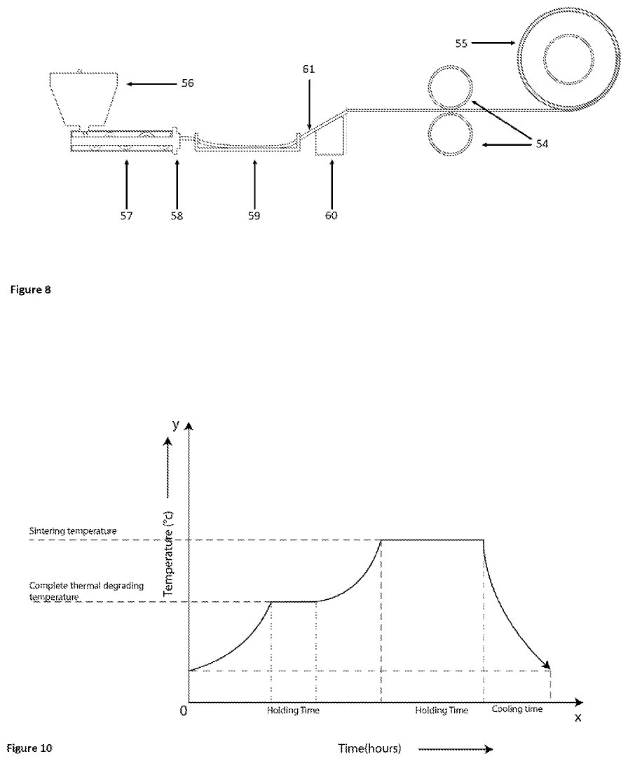

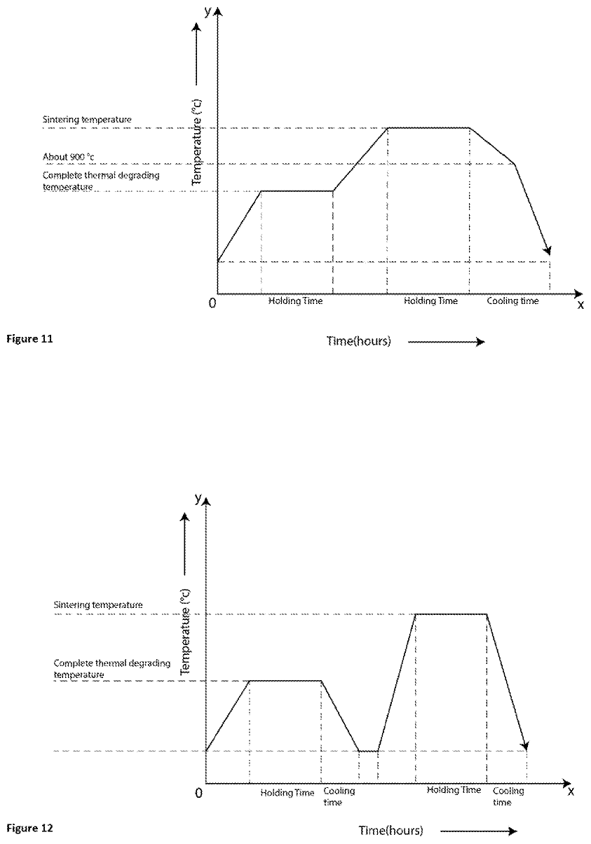

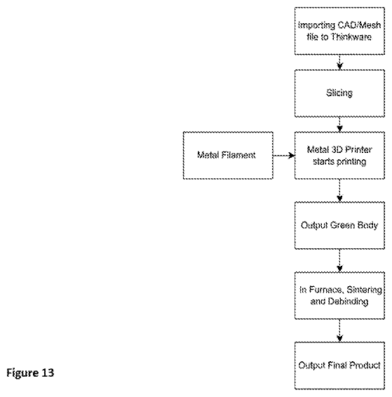

FIG. 1D is a transparent schematic diagram of the apparatus for three-dimensional printing metal objects via fused filament fabrication technique, wherein
11. Is a structural pillar of the apparatus, which is an integral part of the frame,
12. Is the top mount platform, where all the machine components of the apparatus are assembled,
13. Is a wire channel through which all the apparatus wires are passing through,
14. Is the bottom plate that encloses and holds all the apparatus electronic components,
15. Is the smooth rod that facilitates movement of the bed of the apparatus in the Z,
16. Is the bed/build platform of the apparatus on which the molten primary metal material mixture is deposited,
17. Is a type of screw mechanism that facilitates movement of the bed of the apparatus in Z axes,
18. Is a power supply unit, that supplies power to the apparatus,
19. Is a controller mount,
20. Is the extruder casing of the extruder of the apparatus,
21. Is the Z end stop mount of the apparatus,
22. Is a type of nut to the screw that facilitates movement of the bed of the apparatus in Z axes,
23. Is a type of linearof bearing that supports the relative movement of the bed to the smooth rods,
24. Is a type of adjustable screw,
25. Is a stepper motor that facilitates movement of the bed of the apparatus in Z axes;

FIG. 1E is a transparent schematic diagram of the apparatus for three-dimensional printing metal objects via fused filament fabrication technique from the isometric view;

FIG. 2 is a schematic diagram of two print heads, one that deposits molten primary metal material mixture using an extruder and the second extruder used for depositing the graphite mixture material for support structures, of the FFF metal three dimensional printing apparatus, wherein,
26. Is the primary metal material mixture filament,
27. Is an element that is used to stop the heat from travelling through, referred to as the heat break,
28. Is an element that is used to heat the primary metal material mixture filament, also referred to as the heater block,
29. Is a nozzle of the deposition system,
30. Is the molten primary metal material mixture filament,
31. Is a base layer of graphite/graphite mixture material for the primary metal material and/or for internal and/or overhang 3D printing process;

FIG. 3 is a schematic diagram of the three dimensional metal printing apparatus and the logic diagram of the functioning of the three dimensional printing apparatus;

FIG. 4 is a schematic diagram of the a piece of heating equipment of the three dimensional printing apparatus, wherein,
32. Is the top covering to the heating chamber,
33. Is the side panel to the heating equipment of the three dimensional metal printing apparatus,
34. Is a bell shaped heating chamber which could be made out of but not limited to graphite and/or metal and/or ceramic,
35. Is the heating chamber bed/platform on which the green part is placed,
36. Is a lift mechanism that moves in Z direction,
37. Is a transparent front peeping door,
38. Is an inlet for gas into the heating chamber of the piece of heating equipment of the three dimensional metal printing apparatus,
39. Is a type of controller of the piece of heating equipment of the three dimensional metal printing apparatus,
40. Is an ammeter of the piece of heating equipment of the three dimensional metal printing apparatus,
41. Is a type of switch button of the piece of heating equipment of the three dimensional metal printing apparatus,
42. Is another type of switch button of the piece of heating equipment of the three dimensional metal printing apparatus,
43. Is an outlet for gas from the heating chamber of the piece of heating equipment of the three dimensional metal printing apparatus;

FIG. 5 is a schematic diagram of the three dimensional metal printing process—3d printing, debinding, sintering and heat treatment to obtain a near net shape object using a support structure material printing and easy removal;

FIG. 6 is a schematic diagram of the three dimensional functionall printing process-debinding, sintering and heat treatment to obtain a near net shape object using a graphite/graphite mixture support structure material printing and easy removal, wherein,
44. Is a three dimensioanlly printed Material,
45, Is a base support structure to the first layer of primary metal,
46. Is the metal material mixture that could be used to yield physical properties,
47. Is the built platform/bed of the three dimensional metal printing apparatus,
48. Is the material deposition system of the three dimensional metal printing apparatus;

FIG. 7 is a schematic diagram of the of the screw deposition system mounted on the gantry of the three dimensional metal printing apparatus wherein,
49. Is a hopper for of the of the screw deposition system of the three dimensional metal printing apparatus,
50. Is an extrusion screw of the deposition system of the three dimensional metal printing apparatus,
51. Is an element that is used to heat the primary metal material mixture filament, also referred to as the heater block
52. Is a nozzle of the screw deposition system,
53. Is a three dimensional metal printed part on the screw deposition three dimensional printing apparatus;

FIG. 8 is a schematic diagram of the of the filament extrusion system of the three dimensional metal printing apparatus wherein,
54. Is a roller coupled with a tensioner to manipulate the filament diameter of the filament extrusion system,
55. Is a spool roller that winds the filament onto the spool to collect the metal material mixture filament,
56. Is a hopper for the novel mixture to go in,
57. Is a type of screw filament extrusion system which could be single or co-rotating twin or counter-rotating twin screw,
58. Is the pressure die of the screw filament extrusion system,
59. Is an aqueous bath of the screw filament extrusion system,
60. Is a gauge meausuring apparatus used to determine the diamtere of the screw filament extrusion system,
61. Is the primary metal material mixture filament coming out of the filament extrusion system that could be used as a feedstock;

FIG. 9, 10, 11, 12 is a schematic diagram of the of the temperature transformation curve of the heating apparatus wherein the heating rate is constant and debinding, sintering and heat treatment is done in a single process; is a schematic diagram of the of the temperature transformation curve of the heating apparatus wherein the heating rate is variable and debinding, sintering and heat treatment is done in a single process; is a schematic diagram of the of the temperature transformation curve of the heating apparatus wherein the heating rate is constant and debinding, sintering and rapid cooling done in a single process; is an additional schematic diagram of the of the temperature transformation curve of the heating apparatus wherein the heating rate is constant and debinding, sintering and heat treatment is done in a longer single cycle respectively; and

FIG. 13 is a complete block diagram of the of the three-dimensional metal printing process.

### DETAILED DESCRIPTION OF THE PREFERRED EMBODIMENTS

Conventionally, Fused Filament Fabrication (FFF), also known as Fused Deposition Modelling (FDM), is a popular 3D printing technology used for creating parts and prototypes using a range of materials, including metals. While FFF technology was initially developed for printing with thermoplastics, advancements in material science have allowed for the development of metal-infused filaments, which can be used to print metal parts through the FFF process.

The FFF process involves the extrusion of a filament, typically made of a thermoplastic base material mixed with metal powders, through a heated nozzle. The filament is melted in the nozzle and then deposited onto the build platform layer by layer to create the desired 3D object.

The nozzle moves along a predetermined path, controlled by software, to deposit the material in the correct locations, creating a solid object. The process of metal 3D printing through FFF technology begins with the selection of the appropriate metal-infused filament. These filaments are typically composed of binder material, mixed with metal powders, such as copper, aluminium, or stainless steel. The metal powders are typically fine particles, with a size range of around 5-50 micrometres, which are mixed with the binder material in a precise ratio to achieve the desired properties and print quality.

Once the filament is loaded into the 3D printer, the printing process begins. The heated nozzle melts the filament as it is extruded, allowing it to flow smoothly and evenly onto the build platform. The print head moves back and forth along the X and Y axes, while the build platform or the print bed moves up and down along the Z axis, depositing the material in the selective locations to build up the object layer by layer. After the object is fully 3D printed, it undergoes post-processing steps to remove the binders and consolidate the metal particles into a solid metal structure. The first step in this process is typically debinding, which involves removing the binder from the metal particles. This is typically done through chemical methods, depending on the type of binder used. Typically, debinding is achieved using catalytic debinding. In this process, the three-dimensional/3D metal printed part is immersed in a debinding fluid which is maintained at a temperature to produce vapours of the debinding fluid which facilitate debinding. A fluid which helps debinding is used as per the nature of the bond of the polymer. The debound part then undergoes a sintering process, which is essential for achieving full-density metal parts. In the sintering process, the brown part is heated to a high temperature, causing the metal particles to fuse together, creating a fully dense metal part.

Conventionally, ceramics have been widely used as support structures in FFF metal 3D printing due to their high-temperature resistance, compatibility with sintering processes and easy removal of the support material post sintering. Ceramics exhibit excellent thermal stability and mechanical strength at elevated temperatures, making them suitable for supporting metal parts during sintering. However, ceramics have some drawbacks that limit their effectiveness as support structures. Ceramics are generally brittle, making them prone to cracking or breaking. Moreover, sometimes the removal of ceramic support structures could be challenging and time-consuming, especially in small & tricky areas. Therefore, there is a need for an alternative support structure material that overcomes the limitations of conventional ceramics. This alternative material should possess sintering capability compatible with the primary metal material, exhibit thermal stability, and facilitate easy removal from the printed part after sintering.

The present invention introduces a solution to the challenges encountered when 3D printing overhanging, fragile, and complex structures in 3D printing by utilizing graphite as the material for support structures. Graphite, a form of carbon, is selected as the ideal material due to its unique properties that align with the requirements of metal 3D printing. Graphite exhibits a sintering window that is compatible with the sintering range of the primary metal material, making it suitable for simultaneous processing. The sintering window for graphite aligns well with the sintering requirements of various metal powders.

Graphite's unique properties make it an ideal material for support structures in metal 3D printing. Firstly, graphite possesses a compatible sintering window with the primary metal material. This means that both materials can be subjected to the sintering process at the same temperature and duration, ensuring optimal sintering conditions for both the primary structure and the support structure. The compatibility of sintering windows allows for simultaneous processing, streamlining the manufacturing process and improving efficiency. Moreover, graphite exhibits excellent thermal expansion properties, which are crucial for support structures in high-temperature environments. During the sintering process, the primary metal material and the support structure are subjected to elevated temperatures. If the support structure expands significantly during this process, it can cause distortion or deformation of the primary structure, compromising the overall quality of the printed part. However, graphite's thermal expansion properties are well-suited for the support structure's role. It can withstand high temperatures without significant expansion, ensuring minimal interference with the primary structure and maintaining its dimensional accuracy. Another advantage of utilizing graphite as the support structure material is its ease of separation from the primary structure after the sintering process. Traditional ceramic support structures could sometimes be labor-intensive post-processing methods for their removal. In contrast, graphite can be easily separated from the primary structure, either by mechanical means or through simple post-processing techniques. This ease of removal saves time and effort, reducing the risk of damaging the primary structure and ensuring a clean and smooth final product. Furthermore, the invention's utilization of graphite as the support structure material offers economic benefits.

Graphite is a widely available and cost-effective material compared to conventional ceramic options. Its affordability makes it suitable for large-scale production and helps reduce overall manufacturing costs. By providing a cost-effective alternative, the invention enables broader access to metal 3D printing technology, opening up opportunities for various industries and applications. The present invention proposes a specific method for implementing graphite-based support structures in 3D printing. The process involves utilizing atleast one print head, extruding the primary metal material and graphite alternately when & where required, respectively, to print the primary structure and the support structure. The combined green part, consisting of both materials, is then subjected to a debinding process to remove the binders in both the primary metal mixture material and the graphit mixture material. Subsequently, the part undergoes sintering, where the primary metal material and the graphite support structure are sintered simultaneously within their compatible sintering window. After the sintering process, the support structure made of graphite can be easily separated from the primary metal structure through post-processing techniques, ensuring a clean and precise final product. The removal of the support structure does not cause damage or distortion to the primary structure, allowing for the fabrication of complex, fragile, and overhanging structures with high accuracy and integrity.

A novel material mixture (compositions) has been formulated, which includes but is not limited to graphite powder and/or a mixture of inorganic compounds and/or organic compounds such as but is not limited to thermoplastic polymers and/or thermoplastic elastomers and/or thermosetting polymers as a binder(s), long chain fatty acids, and olefinic waxes. The long-chain fatty acids used in the material mixture can be any suitable fatty acid, such as but not limited to calcium stearate, stearic acid, behenic acid, or palmitic acid. The binder material in the mixture can be completely thermally degraded using the same thermal cycle as the primary metal material mixture in a piece of heating equipment, such as but not limited to a furnace, oven, heating coil, heat exchanger, etc., with a controlled environment before sintering the “brown part” in an inert environment. The residual brown part that remains inside the heating equipment, such as but not limited to a furnace, oven, heating coil or any other suitable piece of heating equipment, is then sintered and heat treated in a controlled environment to prevent oxidation of the primary metal material structure parts in the very same thermal cycle.

In 3D printing, support structures play a crucial role in facilitating the creation of complex geometries and aiding in the 3D printing of overhangs. The support material must be easily removable without requiring complex equipment, and it should not cause damage to the primary metal material during 3D printing, debinding, or sintering. In one embodiment of the present invention, graphite has been discovered to be an ideal support material due to its ability to fulfil the aforementioned properties. The new material mixture offers numerous advantages over conventional materials. The inclusion of graphite in the mixture as a support material makes the process of removing support structures easier and less time-consuming, which enhances the efficiency of the 3D printing process. Additionally, the mixture's use of a binder system containing inorganic and/or organic compounds improves its processability at lower temperatures, allowing for easier melting and extrusion of filaments without breakage.

An apparatus is disclosed that comprises at least two print heads, with one print head having the capability to deposit a primary metal material filament and the other print head having the ability to deposit graphite material layer by layer on the build platform or bed, to produce a support structure that facilitates the 3D printing of overhangs. The deposition of the two filaments could be done simultaneously or turn-by-turn. This allows for the creation of structures with internal and/or external overhangs, thereby making it possible to print more complex geometries.

In another embodiment, the apparatus comprises atleast one print head that can alternate between depositing the primary metal material and the support structure material as needed. This can be achieved through the use of a suitable mechanism, such as a switchable feeding mechanism. By depositing the appropriate materials turn-by-turn, the apparatus can create structures with greater complexity such as designs with internal and/or external overhangs.

The use of graphite as a support structure offers several key advantages. Graphite has low hardness, which means that the primary metal part being printed will not get damaged when the part is getting sintered. In addition, graphite has good thermal conductivity, which can help prevent warping or deformation of the primary metal part during the sintering process.

In an embodiment of the present invention, a method of printing a metal part using graphite as a base support material for good bed adhesion of the first layer of primary metal material is provided. In this embodiment, the first layer of the metal part is printed onto a build platform or bed made after a few layers of graphite are 3d printed. It is then followed by the deposition of the subsequent layers of the primary metal material mixture. This sequential deposition of the primary metal material atop graphite layers ensures that the metal part created atop does not warp under any circumstances, thus resulting in a more dimensionally stable part. This method also ensures good adhesion of the first primary metal material when deposited onto the build plate or bed, resulting in good dimensional accuracy and fewer failed 3d prints due to poor build plate or bed adhesion.

Moreover, the use of graphite as a base support material for good bed adhesion of the first layer of primary metal material allows for easy removal of the base support after the debinding and sintering stages without causing damage to the primary metal material. Additionally, graphite's low hardness and good thermal conductivity make it a suitable base support material for good bed adhesion of the first layer of the primary metal material for use in 3d printing metal parts. This could also enable the creation of efficient support structures with internal and/or external overhangs rising from the base support, making it possible to create complex geometries with high precision and accuracy.

In some embodiments, the graphite used for printing the first layer may be modified to include additives that enhance its properties. For example, graphite may be modified to have higher heat retention for better bed adhesion, which would result in even better dimensional stability of the final part. Alternatively, the graphite could be modified to have a higher coefficient of friction, which could improve the adhesion of the first primary metal layer to the build plate or bed, or the coefficient of friction could be lowered to have an easy separation of the support structure from the primary metal structure.

In another embodiment, the printing process may involve the use of two print heads, one for depositing the primary metal material and the second for depositing the graphite support material either for the base or for the overhangs. The two filaments could be deposited simultaneously or turn by turn, enabling the creation of complex structures. In yet another embodiment, a single print head may alternate between depositing the primary metal material and the support material when needed, through the use of a suitable mechanism, such as a switchable feeding mechanism. This turn-by-turn deposition of the appropriate materials allows the apparatus to create structures with greater complexity as and when required.

The novel material mixture used in the support structure for but not limited to the base layer for the primary metal material and/or for internal and/or overhangs 3D printing process comprises graphite powder, one or multiple metal powder(s), and/or a mixture of metal powder(s) and/or alloy powder, inorganic compounds and/or organic compounds such as but not limited to thermoplastic polymers and/or thermoplastic elastomers and/or thermosetting polymers as a binder(s), long chain fatty acids, and olefinic waxes. Suitable long-chain fatty acids include but are not limited to calcium stearate, stearic acid, behenic acid, or palmitic acid. The composition is blended thoroughly and extruded in a manner that results in graphite filaments with a consistent and uniform diameter.

In 3D printing, support structures play a significant role in the design of overhangs and the creation of complex geometries. It is crucial that the support material is easily removable without requiring the use of complex equipment. Furthermore, the support structure material must not damage the primary metal material during 3D printing and/or debinding and/or sintering. Graphite has been found to be highly suitable as a support material that satisfies these requirements.

In summary, the disclosed apparatus comprises at least one print head, having the capability to deposit a primary metal material filament & deposit graphite/graphite mixture material alternately when and where required, layer by layer on the build platform or bed to create a support structure for 3D printing overhangs and/or a base support material for good bed adhesion of the first layer of primary metal material allowing for easy removal of the base support after debinding and sintering stages without causing damage to the primary metal material. The use of graphite as a support structure material offers several key advantages, including low hardness, coefficient of friction, thermal expansion and good thermal conductivity. Additionally, the material mixture used in the support structure for but not limited to the base layer for the primary metal material and/or for internal and/or overhang 3D printing process comprises graphite powder, inorganic compounds and/or organic compounds such as but not limited to thermoplastic polymers and/or thermoplastic elastomers and/or thermosetting polymers as a binder(s), long chain fatty acids, and olefinic waxes. Overall, the embodiments described above offer several advantages over conventional 3d printing methods, including improved dimensional accuracy, enhanced support structure removal, and the ability to create complex geometries with high precision and accuracy. The support structures facilitate the creation of complex geometries, and the use of turn-by-turn deposition of the appropriate materials makes it possible to create structures with greater complexity such as designs with internal and/or external overhangs.

In one embodiment exemplifying the present invention, a Computer-Aided Design (CAD) file is prepared using Thinkware software for the purpose of 3D printing. The software performs the necessary operations to enable the printer to produce a designated “green” part using primary metal material filament, as well as a corresponding support structure fabricated from a filament composed of a graphite mixture material. To achieve this, the software generates a specific set of codes instructing the printer to execute precise movements along the XY plane, heat the nozzle, extrude the primary metal material filament from the nozzle, and advance the build platform or bed in order to deposit molten layers of the primary metal material filament in a sequential manner. Additionally, the printer utilizes either the same extruder or an additional one to extrude the graphite mixture support material filament, allowing for the deposition of molten layers of the support graphite material filament where and when required to provide support for overhangs and underhangs. The primary metal part is produced using a filament consisting of a Stainless Steel 304 material mixture, while the support structure is printed using a filament containing a mixture of graphite material. Once the green part has been successfully printed, it is extracted from the 3D printer and transferred into a furnace. Within the furnace, a heating chamber is provided to accommodate the green part during subsequent thermal treatment. This heating chamber can be constructed using various materials, including but not limited to metal, quartz, ceramic, or graphite, depending on the desired characteristics. Upon placement of the green part within the furnace, it undergoes a controlled heating process aimed at reaching a temperature of approximately 450 degrees Celsius over the course of approximately one hour, with a heating rate of around 10 degrees Celsius per minute. Furthermore, a mixture of gases, such as Nitrogen, Hydrogen, and/or Argon, is introduced into the heating chamber to eliminate any superfluous gases present. The green part, along with its accompanying graphite support, is subjected to this elevated temperature for approximately one hour, allowing for the complete thermal degradation of binders contained within both the primary metal material mixture and the support graphite material mixture. To ensure optimal conditions, the heating chamber may be subjected to vacuuming and/or additional flushing with a mixture of Nitrogen, Hydrogen, and/or Argon gases to eliminate any residual unwanted gases. Following the thermal treatment described above, the temperature within the heating chamber is gradually increased over the span of approximately one hour to reach the sintering temperature of approximately 1380 degrees Celsius, specifically suitable for Stainless Steel 304. This temperature is maintained for several hours, typically around two hours, in the presence of a vacuum and/or endothermic gases, such as Nitrogen, Hydrogen, and/or Argon. The sintering process results in the formation of a fully dense metal part while simultaneously preserving the integrity of the graphite support structure. Once the sintering process is complete, the heating chamber is allowed to cool naturally, or alternatively, it may be cooled naturally until reaching a temperature of approximately 900 degrees Celsius, after which rapid cooling can be initiated. Once the part has been completely cooled, it is retrieved from the furnace. Separating the graphite support structure from the primary metal part is a straightforward task due to the unique properties of graphite. Graphite, being a relatively soft material with a low coefficient of friction, facilitates the easy detachment of the support structure from the primary metal part while maintaining the structural integrity of both components.

In conclusion, the present invention encompasses a method for 3D printing utilizing CAD files and employing a unique combination of materials for the primary metal part and support structure. Through careful control of heating, thermal degradation, sintering, and cooling processes within a dedicated furnace, a high-quality, fully dense metal part with an accompanying graphite support structure is produced. The method described ensures efficient fabrication and subsequent separation of the primary metal part and support structure, making it advantageous for various applications.

One of the challenges of 3D printing through Fused Filament Fabrication (FFF) material extrusion or material deposition technology is the dire need for material particles to be uniformly dispersed throughout the filament, in order to maintain consistent properties and quality of the printed object. To ensure that the graphite powder particles are evenly dispersed throughout the filament and that the printed object has consistent properties and quality, graphite powders are frequently mixed with the binder material. This process is referred to as compounding, and it involves melting the base material and blending it with the graphite powders prior to extruding it into filament form. During the compounding process, the graphite powders are thoroughly mixed with the base material in a controlled environment to ensure uniform distribution. The graphite powder(s) are chosen based on their desired properties, such as but not limited to strength, conductivity, and thermal resistance, and they are mixed in precise proportions to achieve the desired characteristics of the final product.

In one embodiment, the material mixture; is the binder material blend with the graphite powder in a piece of equipment such as but not limited to twin screw extruder, and/or single screw extruder and/or blender and/or pelletizer and/or in any combination is used to compound the material mixture. During the compounding process, the graphite powders are thoroughly mixed with the binder material in a controlled environment to ensure uniform distribution. By using compounding to mix the graphite powders with the binder material, the resulting filament is more uniform in composition, which allows for more consistent properties and better quality in the printed object. Once the graphite powders and binder material have been thoroughly mixed, the resulting compound is pelletized.

Pelletization is the process of forming small, uniform pellets or granules from a material. The process involves compressing the compounded material mixture into a small, dense pellet or granule. The compounded mixture is then fed into a pelletizer, which uses but is not limited to a rotating drum and/or twin screw extruders and/or another mechanism to compress the material into small pellets or granules. As the material passes through the pelletizer, it is subjected to pressure and friction, which helps form the pellets. The size and shape of the pellets can be controlled by adjusting the speed of the pelletizer and the size of the openings in the drum.

Once pelletized it is then extruded through a small opening to form a filament of uniform diameter. It is essential that the filament diameter is uniform to ensure uniform deposition of graphite material mixture. This process of extrusion may be done using but is not limited to a twin screw extruder and/or single screw extruder and/or any other piece of equipment that essentially forms filaments of graphite material mixture. One method for achieving uniform filament size is to manipulate extrusion speed and/or adjust pulling force, and/or vary nozzle diameter. The implementation of these techniques assures uniformity in filament size. The filament is then cooled in but not limited to an aqueous bath and wound onto a spool. It is now ready for use in the support structure by deposition of graphite mixture in the 3D printing process.

In accordance with one embodiment, material deposition 3D printing poses an additional challenge, which is to maintain a constant flow of material mixture filament. Material mixture powders, due to their abrasive nature, can lead to damage to the printer nozzle, leading to blockages and other complications. To overcome this obstacle, customized nozzles with specific physical attributes have been developed. These attributes include high hardness, low coefficient of friction, low specific wear rate, and high thermal conductivity materials. For instance, Vanadium Carbide has been identified as an effective material to manage the hardness of metal filaments.

In one example, the nozzle is designed to operate at a temperature that is higher than the melting point of the material mixture powder, and its interior is coated with a wear-resistant material to prevent wear and tear and is manufactured with a specific diameter and an angled shape to optimize the flow of the abrasive-infused filament. Thus, this embodiment addresses the issue of maintaining a constant flow of abrasive-infused filament by developing a customized nozzle with specific physical properties, such as hardness and wear resistance. This can prevent blockages and other complications, ultimately leading to a more efficient and seamless 3D printing process.

In an additional embodiment of the invention, the material mixture comprises a binder material blend in combination with one or more types of graphite powder and/or fine sand powder. This material mixture is compounded within a controlled environment to ensure that the powder components are uniformly distributed. The compounding process takes place in a single piece of equipment or a combination of multiple pieces of equipment. The resulting mixture is then directly extruded to form a dense, uniformly distributed graphite mixture filament. The filament is subsequently cooled in a suitable medium, which may include but is not limited to an aqueous bath, and wound onto a spool for ease of handling. The resulting filament is now ready for use in the support structure printing in the 3D printing process.

Yet an additional embodiment of the present invention includes using a binder material with a relatively smaller particle size compared to the graphite powder, such that the binder material powder fills up the tetrahedral/octahedral spaces while being blended for a uniform mixture. The material mixture (composition) is then thoroughly compounded and extruded to produce graphite filaments with uniform and consistent diameters. Another embodiment of the invention involves the use of a material mixture consisting of a binder material blend combined with one or more types of graphite powder and/or sand powder. This mixture is prepared within a single piece of equipment or a combination of multiple pieces of equipment and is obtained in the form of dense uniform material mixture pellets. The dense uniform material mixture pellets can be extruded directly using a suitable apparatus, and the resulting molten material mixture can be deposited layer by layer on the build platform or bed. This process essentially creates the object using the material mixture pellets as the starting feedstock.

A suitable setup for this purpose could include a screw extruder, such as a single screw extruder or a co-rotating twin extruder or a counter-rotating twin screw extruder or any other piece of equipment, mounted on the gantry as the print head. The print head moves back and forth along the X and Y axes, while the build platform or the print bed moves up and down along the Z axis, depositing the material in selective locations to build up the object layer by layer. This setup enables the production of complex structures with precision and accuracy, using the dense uniform material mixture pellets as the feedstock.

In another embodiment including a print head comprising one or more pieces of equipment mounted on the gantry of the 3D printer. The print head is capable of compounding a material mixture consisting of a binder material blend combined with one or more types of graphite powder and/or sand. This setup allows for direct deposition of the material mixture onto the build platform or bed layer by layer, eliminating the need to create pellets, filaments, or rods.

In one embodiment of the present invention, the material mixture(s) enable 3D printing of the metal material mixture at low temperatures. Specifically, in one example, the molten material mixture can be deposited in fine layers of around but not limited to 120 degrees Celsius. This low-temperature printing process has several advantages, including reduced energy consumption, less material degradation, and less thermal stress on the printed part.

In another embodiment, the material mixture(s) enable 3D printing of the metal material mixture at slightly higher temperatures. For example, the molten material mixture can be deposited in fine layers of around but not limited to 200 degrees Celsius. This slightly higher temperature printing process could have advantages such as faster printing speeds and better surface finish quality.

Additionally, in one embodiment, the environment/ambience is heated, and the ambient temperature is raised during the printing process. For example, the ambient temperature could be around but not limited to 70 degrees Celsius. The ambient temperature is dependent on the thermal conductivity of the material mixture(s). A material that has high thermal conductivity and is more prone to warping as it loses heat readily needs to be deposited at an elevated temperature to avoid warping. A heated printer chamber, therefore, facilitates better-printed support structures. It is important to note that the selection of the printing temperature depends on several factors, including the material properties, the desired properties of the printed part, and the printing environment. The temperature should be carefully chosen to ensure that the printed part is of the desired quality and is scientifically sound.

In conclusion, the present invention provides a versatile method for 3D printing support structures using a graphite material mixture(s) that can be printed at low temperatures or slightly higher temperatures, depending on the desired outcome. Moreover, the use of a heated printer chamber ensures better print quality by reducing warping and promoting good adhesion between the layers. The present invention provides a valuable contribution to the field of 3D printing of metal parts by providing supports to complex and over and/or under hanging parts enabling manufacturing of parts that are very complex and perhaps cannot be yield using conventional forms of manufacturing.

In some embodiments, the components of the binder(s) are organic, thermoplastic polymers, which can be completely thermally degraded during the sintering process. The use of such polymers in the binder system provides several advantages. For example, thermoplastic polymers and/or thermoplastic elastomers are easily processable and can be melted and extruded to form filaments. Furthermore, incorporating thermoplastic polymers as binders can enhance the mechanical characteristics of the green part, thereby enabling safe handling of the green part without causing any harm.

In some embodiments of the present invention, the binder system for the material of the support structure in 3D printing of metal parts includes organic thermoplastic elastomers that can be thermally degraded during the sintering process. One significant advantage is the ease of processing of the thermoplastic elastomers. Due to their low melting point and ease of extrusion, these materials can be melted and extruded to form filaments that can be wound onto a spool without breakage. Furthermore, incorporating thermoplastic elastomers as binders can enhance the mechanical properties of the graphite mixture filament, making it more flexible and easier to handle during the printing process. In addition to their ease of processing and improved mechanical properties, the use of thermoplastic elastomers as binders can also offer benefits in terms of the sintering process. During the sintering process, the binder material must be completely removed to ensure the integrity of the final metal part. The use of thermoplastic elastomers as binders ensures that the material can be completely degraded without the need for additional steps. This characteristic simplifies the overall production process, reducing the time and cost required for the production of highly complex/exotic metal parts.

In an additional embodiment of the invention, the binder(s) system used in 3d printing support structures in 3D printing metal parts can comprise organic, thermosetting materials. Unlike the organic, thermoplastic elastomers described in the previous embodiment, which are melt-processable and can be easily extruded into filaments, thermosetting materials are cross-linked during the curing process and become insoluble and infusible. The use of thermosetting materials as binders in the graphite-infused filament provides several advantages. For example, thermosetting materials can be cured at relatively low temperatures and have excellent adhesion properties. The cured binder is chemically resistant and mechanically stable, making it ideal for use in 3D printing applications where dimensional stability and chemical resistance are critical.

In some embodiments, the thermosetting materials used in the binder(s) system may include but is not restricted to epoxy resins, phenolic resins, or silicone resins. These materials can be mixed with the graphite powder and any desired reinforcements to form a paste-like material, which can be extruded through the printer nozzle and deposited layer-by-layer to form the desired metal part. During the printing process, the thermosetting binder(s) material is cured by heat, either during or after the deposition of the material. The curing process is triggered by the application of heat, which causes the thermosetting material to crosslink and become a rigid, infusible solid. This curing process is irreversible, which means that the cured binder(s) material cannot be melted or reprocessed. One advantage of using thermosetting materials as binders is that they can be cured at relatively low temperatures, typically in the range of 100-150° C. This allows the printed part to be removed from the printer bed and transferred to a separate piece of heating equipment such as but not limited to the furnace or an over or any other equipment for the debinding, sintering & heat treatment process. During debinding and sintering, the binder(s) material is completely removed and sintering the primary metal part with the graphite structure, leaving behind a fully dense metal part 3d printed with graphite support structure with excellent mechanical properties and an unmatched complexity.

In some embodiments, the use of thermosetting materials as binders can also improve the mechanical properties of the printed part. For example, the cured binder(s) material can act as a reinforcing agent, improving the strength of the part required for handling. In addition, the use of thermosetting materials as binders can also improve the dimensional accuracy and surface finish of the printed part. Overall, the use of thermosetting materials as binders in 3D printing graphite support structure provides several advantages, including improved mechanical properties for handling, dimensional accuracy, and surface finish. The cured binder(s) material is chemically resistant and mechanically stable, making it ideal for use in applications where dimensional stability and chemical resistance are critical. Furthermore, the low curing temperatures allow the printed part to be transferred to a separate piece of heating equipment such as but not limited to the furnace or an over or any other equipment for the debinding, sintering & heat treatment process providing a versatile and efficient 3D printing process for producing metal parts with removable graphite support structures.

According to the embodiment of the present invention, the process comprises a sinterable composition which will comprise any sinterable material and a thermally degradable binder system. In many embodiments, the sinterable material can be but is not limited to graphite powder and/or sand powder. In some embodiments, the reinforcements can be but are not limited to nanomaterial, ceramic powder etc. The binder system comprises binder(s) and lubricant(s) in variable percentages by volume. Long-chain fatty acids, such as calcium stearate, stearic acid, behenic acid, or palmitic acid, could be used as lubricants to reduce friction and prevent wear and tear on the printer's nozzle during the printing process and allow for easy mixing of the graphite powder. Long-chain fatty acids and olefinic waxes could also be added to the mixture to improve the flowability of the material mixture.

In another embodiment of the invention, clay is identified as a suitable support material for material extrusion 3D printing or Fused Filament Fabrication (FFF) 3D printing processes. Clay, renowned for its wide availability and cost-effectiveness, exhibits characteristics that make it highly suitable for serving as a support structure material in additive manufacturing applications. The unique properties of clay allow for easy shaping and subsequent removal from the main structure after 3D printing and sintering processes have been completed. Clay's inherent malleability and flexibility make it an ideal material for rapid prototyping purposes. Its ability to be shaped into intricate forms and structures with ease facilitates the creation of complex designs with fragile and delicate details. This aspect of clay is particularly advantageous in situations where the manufacturing process necessitates the inclusion of intricate features or the realization of highly detailed objects.

Moreover, the cost-effectiveness of clay as a support structure material further enhances its appeal for various additive manufacturing applications. Clay is widely available in abundant quantities, making it easily accessible and affordable for manufacturers. The comparatively low cost of clay compared to other support structure materials makes it an economical alternative, contributing to overall cost savings in the manufacturing process. By employing clay as a support structure material in material extrusion 3D printing or FFF 3D printing, manufacturers can leverage its properties to achieve optimal results. The utilization of clay facilitates the printing of intricate designs and delicate structures without compromising the stability of the primary structure. This is attributed to clay's ability to provide adequate support during the printing process, ensuring the integrity of the primary structure is maintained. Once the 3D printing and sintering processes have been completed, the removal of clay as a support material is a straightforward procedure. Its inherent characteristics allow for easy separation from the main structure without causing damage or deformation to the final product. The removal process can involve mechanical means, such as physically detaching the clay material or using appropriate solvents to dissolve and eliminate the clay residues, leaving a clean and undamaged surface. In summary, clay represents an additional embodiment for serving as a support material in material extrusion 3D printing or FFF 3D printing processes. The advantageous properties of clay, including its malleability, cost-effectiveness, and ease of removal, make it a compelling choice for supporting delicate and intricate designs. By utilizing clay as a support structure material, manufacturers can successfully realize complex structures while achieving cost savings and maintaining the integrity of the primary structure.

In an additional embodiment, the present invention encompasses the utilization of organic materials as support structures in additive manufacturing processes. Organic materials, including but not limited to various carbon allotropes, exhibit unique properties that make them advantageous in scenarios where extreme heat is involved during the manufacturing process. These materials, renowned for their high thermal stability and low thermal expansion characteristics, offer significant benefits in achieving precise and intricate structures. Carbon allotropes, such as graphite, graphene, carbon nanotubes, and carbon fibres, have garnered considerable attention due to their exceptional mechanical, electrical, and thermal properties. Graphene, a two-dimensional allotrope of carbon, possesses remarkable strength, flexibility, and thermal conductivity. These attributes make it particularly suitable for supporting delicate and intricate structures during additive manufacturing processes when coupled with the right binder and matrix. When employed as a support material, graphene provides exceptional stability and resilience, allowing for the fabrication of complex geometries with improved accuracy and structural integrity. Its high thermal stability ensures that the support material can withstand the elevated temperatures encountered during the manufacturing process without compromising the overall structural integrity of the printed object. The low thermal expansion coefficient exhibited by carbon allotropes, including graphene, is of significant importance in additive manufacturing. The mismatch in thermal expansion coefficients between the support material and the primary material can result in residual stresses and deformations in the final printed object. By employing organic support materials with low thermal expansion, such as graphite, and graphene, these issues can be mitigated, leading to improved dimensional accuracy and reduced distortion in the printed structures.

In another embodiment of the present invention, fine sand is employed as a support structure material specifically tailored for metal 3D printing applications. Fine sand, a widely available and cost-effective material, offers unique characteristics that make it well-suited for supporting the fabrication of intricate metal parts. Fine sand, composed primarily of silica or silicon dioxide, provides excellent thermal stability and high-temperature resistance. These properties are crucial in metal 3D printing processes, as they ensure that the support structure can withstand the extreme temperatures encountered during the manufacturing process without undergoing significant deformations or structural failure. The thermal stability of sand as a support material enables the successful printing of metal parts without compromising the overall dimensional accuracy and structural integrity.

Furthermore, sand exhibits a granular and porous nature, allowing it to efficiently dissipate heat generated during the metal 3D printing process. This heat dissipation capability minimizes the risk of thermal distortion and stress accumulation in the printed metal parts. The porous structure of sand also facilitates the easy removal of the support material after the completion of the printing process, simplifying post-processing operations and reducing the time and effort required for support removal.

Additionally, the granular nature of sand enables effective support distribution, providing reliable support to complex and overhanging geometries. The sand particles can be strategically packed and layered to create stable support structures that adequately support the metal part during the printing process. This support structure ensures the successful deposition of metal layers, prevents structural collapse and promotes accurate geometry replication.

Moreover, sand offers compatibility with various metal materials commonly used in metal 3D printing, such as stainless steel, titanium alloys, and aluminium alloys. The chemical inertness of sand towards these metals ensures that it does not chemically react or contaminate the printed parts during the fabrication process. This compatibility allows for the successful printing of metal parts with precise geometries, intricate features, and high surface quality. The utilization of sand as a support structure material in metal 3D printing processes also provides economic advantages. Sand is abundantly available, making it a cost-effective option compared to some traditional support materials. It's affordability and widespread availability contribute to the overall cost efficiency of metal 3D printing technologies, enabling their adoption in various industrial sectors. In conclusion, the embodiment described herein emphasizes the utilization of sand as a support structure material in metal 3D printing processes. The exceptional thermal stability, heat dissipation capability, compatibility with metal materials, and cost-effectiveness of sand make it a highly suitable choice for supporting the fabrication of intricate metal parts. By incorporating sand as a support material, manufacturers can achieve enhanced dimensional accuracy, reduced thermal distortion, and cost-efficient production of complex metal geometries in metal 3D printing processes.

1. A material mixture for use in 3D printing comprising graphite powder, one or more metal powder(s) and/or a mixture of metal powder(s) and/or alloy powder, inorganic and/or organic compounds such as thermoplastic polymers, thermoplastic elastomers, and/or thermosetting polymers as binder(s), long chain fatty acids and olefinic waxes.

2. An apparatus for 3D printing of structures with complexity comprising at least two print heads, with one capable of depositing a primary metal material filament and the other capable of depositing graphite material layer by layer on the build platform or bed to produce a support structure that facilitates the 3D printing of overhangs, atleast one print head that can alternate between depositing the primary metal material and the support structure material as needed.

3. A method of 3D printing a metal part using graphite as a base support material for good bed adhesion of the first layer of primary metal material, comprising:
Printing a few layers of graphite onto a build platform or bed;
Depositing the first layer of the primary metal material onto the graphite layer; and
Depositing subsequent layers of the primary metal material atop the first layer and graphite layers.

4. The material mixture as claimed in claim 1, wherein the long-chain fatty acids used selected from a group consisting of calcium stearate, stearic acid, behenic acid or palmitic acid.

5. The apparatus as claimed in claim 2, wherein the deposition of the two filaments are made simultaneously or turn-by-turn, enabling the creation of structures with internal and/or external overhangs.

6. The method as claimed in claim 3, wherein the sequential deposition of the primary metal material atop graphite layers ensures good adhesion of the first primary metal material when deposited onto the build plate or bed, resulting in good dimensional accuracy and fewer failed 3D prints due to poor build plate or bed adhesion.
